(19) United States
(12) Patent Application Publication
(10) Pub. No.: US 2026/0200780 A1
(43) Pub. Date: Jul. 16, 2026

(54) MEASUREMENT METHOD AND SYSTEM FOR PRECIPITATION SPEED OF INORGANIC SALT IN WATER, ELECTRONIC DEVICE, AND STORAGE MEDIUM

(71) Applicant: JIYUAN QINGYUAN WATER TREATMENT CO., LTD., Jiyuan (CN)

(72) Inventor: Gaorong HE, Shanghai (CN)

(73) Assignee: JIYUAN QINGYUAN WATER TREATMENT CO., LTD., Jiyuan (CN)

(21) Appl. No.: 19/143,472

(22) PCT Filed: Nov. 29, 2023
(86) PCT No.: PCT/CN2023/135108

§ 371 Date: Mar. 11, 2026

(30) Foreign Application Priority Data
Dec. 28, 2022 (CN) 202211688318.4

(51) Int. Cl. C02F 5/08

(52) U.S. Cl. CPC C02F 5/08; C02F 2209/06; C02F 2209/10; C02F 2209/24

(57) ABSTRACT

The present invention discloses a measurement method and system for the precipitation speed of an inorganic salt in water, an electronic device, and a storage medium. The measurement method comprises the following steps: S1: obtaining the type of an inorganic salt precipitated in water to be measured, one of inorganic carbon methyl orange alkalinity (Cmalk), a pH value, and total dissolved inorganic carbon (DIC) in said water, an element of a target inorganic salt contributing to non-inorganic carbon methyl orange alkalinity and an initial content of the element; S2: continuously measuring a change value of a carbon dioxide concentration (CO2w) in said water or a carbon dioxide concentration (PCO2) in a gas phase in balance with said water over time in a closed constant-temperature and constant-pressure environment; S3: obtaining the precipitation amount of the target inorganic salt according to data obtained in step S1 and step S2; S4: obtaining the precipitation speed of the target inorganic salt according to the precipitation amount obtained in step S3. Provided is a measurement method for the precipitation speed of an inorganic salt in water that achieves less manual intervention, a small measurement lower limit, and high precision.

### TECHNICAL FIELD

The present invention relates to the technical field of water treatment, and more particularly, to a measurement method and system for the precipitation speed of an inorganic salt in water, an electronic device, and a storage medium.

### BACKGROUND ART

Scale is defined as the formation of an undesirably hard layer of salt on a surface; These surfaces may be the surfaces of heat exchangers, water pipes or vessels, pores of rocks, membranes, and membrane pores; Excessive scale will cause the decrease of heat exchange efficiency, the increase of delivery pressure and energy consumption, the decrease of oilfield production efficiency and the damage of oilfield related facilities, the decrease of reverse osmosis membrane efficiency and the damage of facilities; The main chemical methods used to control scale include adjusting the supersaturation of the inorganic salts forming scale, adding scale inhibitors to inhibit the precipitation of inorganic salts, etc; The most common mechanism for controlling scale is to control the crystallization reaction of these salts, i.e. to control the amount and precipitation speed of these salts from water. After judging the main scale types and calculating the supersaturation by combining the water quality parameters and application conditions (e.g. temperature) with the solubility product constant of inorganic salts and designing a scheme for adjusting the crystallization reaction characteristics of the target inorganic salts, the scheme needs to be verified in the laboratory and then put into practical application; One of the main contents in laboratory verification and practical application is to detect the amount and speed of target inorganic salt precipitation from water. In the following, the process of measuring the amount and rate of target inorganic salt precipitation from water in the laboratory is referred to as process 1, and the process of measuring the amount and speed of inorganic salt precipitation from water in field application is referred to as process 2.

The prior art in process 1 is a static scale inhibition method, such as GB/T16632-2008 Determination of scale inhibition performance of water treatment agents-Calcium carbonate precipitation method; HG/T2024-2009 Determination of scale inhibition performance of water treatment agents-Bubble method; HG/T4541-2013 Water treatment chemicals-Determination of scale inhibition performance-Limited carbonate method, the turbidity method disclosed in V. Tantayakom at all., Scale inhibition study by turbidity measurement, Journal of Colloid and Interface Science 284 (2005) 57-65 as well as the conductivity method, the critical pH method, the pH shift method, the dynamic simulation evaluation method, and the like. The above-mentioned methods are all used to characterize the amount of inorganic salt precipitated from water or the critical point at which precipitation starts to occur in a test solution with a certain degree of supersaturation, with some chemical or physical change of the test solution. The static scale inhibition and bubble method were used to calculate the scale inhibition rate (precipitation inhibition rate) with the change of the ion concentration of scale-forming inorganic salt; the limit carbonate method is used to continuously increase the supersaturation degree and periodically determine the concentration of relevant ions in the test. When it is measured that the ion concentration of scale-forming inorganic salts decreases, this is considered to be the critical point for inorganic salts to precipitate from water. For the calcium carbonate scale, the sum of total alkalinity and calcium ion concentration (both calculated as calcium carbonate) at this time is defined as the limit carbonate value; the conductivity method, critical pH method, and turbidity method were used to measure the breakthrough point of conductivity, pH and turbidity, respectively. The supersaturation at the breakthrough point was calculated, and the scale inhibition rate (precipitation inhibition rate), limit carbonate, critical supersaturation ratio, and critical supersaturation value were calculated based on this.

In the prior art in process 2, the ratio of ions such as potassium ions, sodium ions, and chloride ions which are not easily precipitated in water to the ions that may be precipitated also attempts to calculate the precipitation amount and speed of insoluble salts through the mass balance of the quantity of water and the concentration of ions in water; two kinds of fluorescent substances are added into the water in a certain proportion, one of which is synthesized on the scale inhibitor, and the other is considered not to be consumed in water. By monitoring the difference between the two kinds of fluorescent substances, the consumption of scale inhibitor is reflected, and it is considered that the precipitation of insoluble salt will consume the scale inhibitor, thus indirectly reflecting the precipitation amount and speed of insoluble salt, which is hereinafter referred to as 3D TRASAR™ method; monitor the heat exchanger and so on. Theoretically, by measuring the concentration change of the target inorganic ions in the water sample after constant temperature for a certain period of time, it is possible to calculate the precipitation speed of these inorganic substances from the water. Due to the low precipitation speed that must be controlled in a practical application environment and the limited precision and accuracy of prior art analysis of the concentration of these ions, this method cannot be used to achieve this goal.

The capillary method in the dynamic simulation test measures the degree of adsorption of inorganic salts on the capillary by measuring the pressure difference between two sections of the capillary under constant temperature and pressure. This method requires strict control of the capillary flow rate and therefore uses a constant flow pump with high accuracy but low tolerance to suspended matter in the water. Thus, the practical application in the field is limited.

### SUMMARY OF THE INVENTION

It is an object of the present invention to provide a measurement method and a measurement system, an electronic device, and a storage medium for insoluble inorganic salts containing inorganic carbon methyl orange alkalinity which cause alkalinity change after precipitation with less human intervention, a small measurement lower limit, and a high precision of precipitation amount and precipitation speed.

In order to achieve the above-mentioned object, the technical solution adopted by the present invention is to provide a measurement method for the precipitation speed of an inorganic salt in water, comprising the following steps: S1: obtaining the type of an inorganic salt precipitated in water to be measured, one of inorganic carbon methyl orange alkalinity (Cmalk), a pH value, and total dissolved inorganic carbon (DIC) in said water, total dissolved solid content (TDS), an element of a target inorganic salt contributing to non-inorganic carbon methyl orange alkalinity and the content of the element; S2: continuously measuring a change value of a carbon dioxide concentration (CO2w) in said water or a carbon dioxide concentration (PCO2) in a gas phase in balance with said water over time in a closed constant-temperature and constant-pressure environment; S3: obtaining the precipitation amount of the target inorganic salt according to data obtained in step S1 and step S2; S4: obtaining the precipitation speed of the target inorganic salt according to the precipitation amount obtained in step S3 and the time in S2.

Preferably, in said step S1, the other two of the inorganic carbon methyl orange alkalinity (Cmalk), the pH value, and the total dissolved inorganic carbon (DIC) in water are calculated according to the following formulas:

$$D I C = {CO}_{2} w \times ( 1 + {k}_{1}^{′} / ( {H}^{+} ) + {k}_{1}^{′} \times {k}_{2}^{′} / {( {H}^{+} )}^{⋀} 2 ) , \qquad ( 1 )$$

$$Cmalk = 50000 \times {CO}_{2} w \times ( {k}_{1}^{′} / ( {H}^{+} ) + 2 {k}_{1}^{′} \times {k}_{2}^{′} / {( {H}^{+} )}^{⋀} 2 ) , \qquad ( 2 )$$

$$pH = - log ( {H}^{+} ) \qquad ( 3 )$$

where DIC is the total dissolved inorganic carbon concentration in the water (mol/L), CO2w is the carbon dioxide concentration in the water to be measured (mol/L), Cmalk is the inorganic carbon methyl orange alkalinity in the water (mg/L, calculated as calcium carbonate), H+ is a hydrogen ion concentration in the water to be measured (mol/L), k′1 is a first dissociation constant of carbonic acid, and k′2 is a second dissociation constant of carbonic acid.

Preferably, the target inorganic salt is calcium carbonate, and there are no other ions contributing to the inorganic carbon methyl orange alkalinity in the water to be measured, said step S3 comprises the following steps:
S311: knowing Cmalk(t0) and CO2w(t0) at t0, and calculating H+(t0) and DIC(t0) at the starting time t0 according to formulas (2) and (1);
S312: knowing CO2w(t1) at t1, calculating H+(t1) at t1 according to formula (5), calculating Cmalk(t1) at t1 according to formula (2), and calculating DIC(t1) at t1 according to formula (4),

$$( D I C ( {t}_{0} ) - D I C ( {t}_{1} ) ) \times 100 \times 1000 = ( Cmalk ( {t}_{0} ) - Cmalk ( {t}_{1} ) ) \qquad ( 4 )$$

$$2 \times {CO}_{2} w ( {t}_{0} ) - 2 \times {CO}_{2} w ( {t}_{1} ) = {CO}_{2} w ( {t}_{1} ) \times {k}_{1}^{′} / {H}^{+} ( {t}_{1} ) - {CO}_{2} w ( {t}_{0} ) \times {k}_{1}^{′} / {H}^{+} ( {t}_{0} ) \qquad ( 5 )$$

S313: calculating the calcium carbonate precipitation amount according to formula (6)

$$calcium carbonate precipitation amount {CaCO}_{3} = ( D I C ( {t}_{0} ) - D I C ( {t}_{1} ) ) \times {10}^{⋀} 5 , \qquad ( 6 )$$

wherein, the unit of calcium carbonate precipitation amount CaCO₃ is mg/L.

Preferably, the inorganic salt precipitated is calcium phosphate, and no ions are contributing to the inorganic carbon methyl orange alkalinity other than the inorganic carbon methyl orange alkalinity contributed by orthophosphate in the water to be measured, said step S3 comprises the following steps:
S321: knowing Cmalk(t₀) and CO₂w(t₀) at t₀, and calculating H⁺(t₀) and DIC(t₀) at the starting time t₀ according to formulas (2) and (1);
S322: knowing CO₂w(t₁) at t₁, calculating DIC(t₁) and H⁺(t₁) at t₁ according to formula (7), calculating Cmalk(t₁) at t₁ according to formula (2),

$$D I C ( {t}_{0} ) = D I C ( {t}_{1} ) = {CO}_{2} w ( {t}_{1} ) \times ( 1 + {k}_{1}^{′} / {H}^{+} ( {t}_{1} ) + {k}_{1}^{′} {k}_{2}^{′} / ( {{H}^{+} ( {t}_{1} )}^{⋀} 2 ) ) \qquad ( 7 )$$

S323: knowing Tₚ(t₀) at t₀, obtaining DIP(t₀) according to formula (9), calculating Pmalk(t₀) according to formulas (10)-(12), calculating DIP(t₁) according to formulas (8)-(12), and calculating calcium phosphate precipitation amount according to formula (14);

$$( DIP ( {t}_{0} ) - DIP ( {t}_{1} ) / 2 \times 2 \times 50 \times 1 \; 000 = Cmalk ( {t}_{0} ) + Pmalk ( {t}_{0} ) - Cmalk ( {t}_{1} ) - Pmalk ( {t}_{1} ) \qquad ( 8 )$$

$$DIP = Tp / 95 / 1000 \qquad ( 9 )$$

$$Pmalk = ( {PO}_{4}^{3 -} ) \times 2 \times 50000 + ( {HPO}_{4}^{2 -} ) \times 1 \times 5000 \qquad ( 10 )$$

$$( {PO}_{4}^{3 -} ) = Tp / 95 / 1000 \times {kp}_{1} \times {kp}_{2} \times {kp}_{3} / ( {( {H}^{+} )}^{⋀} 3 + {( {H}^{+} )}^{⋀} 2 \times {kp}_{1} + ( {H}^{+} ) \times {kp}_{1} \times {kp}_{2} + {kp}_{1} \times {kp}_{2} \times {kp}_{3} ) \qquad ( 11 )$$

$$( {HPO}_{4}^{2 -} ) = ( {PO}_{4}^{3 -} ) \times ( {H}^{+} ) / {kp}_{3} \qquad ( 12 )$$

$$Calcium phosphate precipitation amount {{Ca}_{3} ( {PO}_{4} )}_{2} = ( DIP ( {t}_{0} \text{---} ) - DIP ( {t}_{1} ) ) / 2 \times 310 \times 1000 \qquad ( 14 )$$

wherein Pmalk is the inorganic phosphorus methyl orange alkalinity (mg/L, calculated as calcium carbonate), DIP is the total dissolved inorganic phosphorus concentration (mol/L), Tp is the total dissolved inorganic phosphorus concentration (mg/L, calculated as PO43−); kp1 is the first ionization constant of phosphoric acid, kp2 is the second ionization constant of phosphoric acid, and kp3 is the third ionization constant of phosphoric acid.

Preferably, the target inorganic salt is magnesium silicate, and no ions are contributing to the inorganic carbon methyl orange alkalinity other than the inorganic carbon methyl orange alkalinity contributed by silicate in the water to be measured, said step S3 comprises the following steps:
S331: knowing Cmalk(t₀) and CO₂(t₀) at t₀, and calculating H⁺(t₀) and DIC(t₀) at the starting time t₀ according to formulas (2) and (1);
S332: knowing CO₂(t₁) at t₁, calculating DIC(t₁) and H⁺(t₁) at t₁ according to formula (7), calculating Cmalk(t₁) at t₁ according to formula (2),

$$D I C ( {t}_{0} ) = D I C ( {t}_{1} ) = {CO}_{2} ( {t}_{1} ) \times ( 1 + {k}_{1}^{′} / {H}^{+} ( {t}_{1} ) + {k}_{1}^{′} {k}_{2}^{′} / ( {{H}^{+} ( {t}_{1} )}^{⋀} 2 ) ) \qquad ( 7 )$$

S333: knowing Tsi(t₀) at t₀, obtaining DISi(t₀) according to formula (16), calculating Simalk(t₀) according to formulas (17) and (18), and calculating DISi(t₁) according to formulas (15)-(18), and calculating the magnesium silicate precipitation amount according to formula (19);

$$( D I S i ( {t}_{0} ) - D I S i ( {t}_{1} ) \times 2 \times 50 \times 1000 = Cmalk ( {t}_{0} ) + Pmalk ( {t}_{0} ) - Cmalk ( {t}_{1} ) - Pmalk ( {t}_{1} ) \qquad ( 15 )$$

$$D I S i = Tsi / 60 / 1000 \qquad ( 16 )$$

$$Simalk = 50000 \times ( {Si ( OH )}_{3} {O}^{-} ) \qquad ( 17 )$$

$$( {Si ( OH )}_{3} {O}^{-} ) = D I S i / ( 1 + {H}^{+} / Ksi ) \qquad ( 18 )$$

magnesium silicate precipitation amount MgSiO₃=(DISi(t₀)−DISi(t₁))×2×50×1000 (19)
wherein DISi is the total dissolved inorganic silicon content mol/L, Tsi is the total dissolved inorganic silicon content mg/L, calculated as SiO₂, Simalk is the inorganic silicon methyl orange alkalinity mg/L, calculated as calcium carbonate, and Ksi is the dissociation constant of silicic acid.

Preferably, the target inorganic salt is colloidal silicon, and no ions are contributing to the inorganic carbon methyl orange alkalinity other than the inorganic carbon methyl orange alkalinity contributed by silicate in the water to be measured, and step S3 comprises the following steps:
S341: knowing Cmalk(t₀) and CO₂(t₀) at t₀, and calculating H⁺(t₀) and DIC(t₀) at the starting time to according to formulas (2) and (1);
S342: knowing CO₂(t₁) and Cmalk(t₁) at t₁, calculating DIC(t₁) and H⁺(t₁) at t₁ according to formula (7), calculating Cmalk(t₁) at t₁ according to formula (2);

$$D I C ( {t}_{0} ) = D I C ( {t}_{1} ) = {CO}_{2} ( {t}_{1} ) \times ( 1 + {k}^{′} 1 / {H}^{+} ( {t}_{1} ) + {k}^{′1} {k}^{′} 2 / ( H + {( {t}_{1} )}^{⋀} 2 ) ) \qquad ( 7 )$$

S343: knowing Tsi(t₀) at t₀, obtaining DISi(t₀) according to formula (16), calculating Simalk(t₀) according to formulas (17) and (18), and calculating DISi(t₁) according to formulas (16)-(18) and (20), and calculating the colloidal silicon precipitation amount according to formula (21),

$$( D I s i ( {t}_{0} ) - D I s i ( {t}_{1} ) \times 1 \times 50 \times 10 \; 00 = - ( Cmalk ( {t}_{0} ) + S i malk ( {t}_{0} ) ) + ( Cmalk ( {t}_{1} ) + Simalk ( {t}_{1} ) ) \qquad ( 20 )$$

$$D I s i = Tsi / 60 / 1000 \qquad ( 16 )$$

$$Simalk = 50000 \times ( {Si ( OH )}_{3} {O}^{-} ) = D I S i / ( 1 + {H}^{+} / Ksi ) \qquad ( 17 )$$

$$( {Si ( OH )}_{3} {O}^{-} ) = D I S i / ( 1 + {H}^{+} / Ksi ) \qquad ( 18 )$$

$$colloidal silicon precipitation amount {SiO}_{2} = ( D I S i ( {t}_{0} ) - D I S i ( {t}_{1} ) ) \times 1 \times 60 \times 1000 \qquad ( 21 )$$

wherein DISi is the total dissolved inorganic silicon content mol/L, Tsi is the total dissolved inorganic silicon content mg/L, calculated as SiO₂, Simalk is the inorganic silicon methyl orange alkalinity mg/L, calculated as calcium carbonate, and Ksi is the dissociation constant of silicic acid; the unit of the colloidal silicon precipitation amount SiO₂ is mg/L.

Preferably, step S2 comprises: measuring a carbon dioxide gas concentration PCO₂ in a closed detector, wherein a gas circulation pump and a carbon dioxide concentration in a gas phase detector are provided in a loop of the closed detector, and continuously recording the carbon dioxide gas concentration PCO₂ during measurement; then converting the carbon dioxide gas concentration PCO₂ into the carbon dioxide concentration CO_{2w} in water according to Henry's law, CO₂w=Kh×PCO₂, and Kh is the Henry constant for carbon dioxide.

In order to achieve the above object, the present invention also provides an electronic device comprising: a processor; a memory, and a computer program stored in the memory and operable on the processor, when the computer program is executed by the processor, the above-mentioned measurement method for the precipitation speed of an inorganic salt in water is implemented.

In order to achieve the above object, the present invention also provides a computer-readable storage medium, a computer program is stored in the storage medium, and when the computer program is executed by a processor, the above-mentioned measurement method for the precipitation speed of an inorganic salt in water is implemented.

In order to achieve the above object, the present invention also provides a measurement system for the precipitation speed of an inorganic salt in water, comprising a closed detector for measuring the carbon dioxide concentration and the above-mentioned electronic device, the electronic device further comprising an input-output module, the output end of the closed detector being in signal communication with the input-output module of the electronic device.

Further, the closed detector comprises a test container, a carbon dioxide detector, a first constant-temperature heating unit, and a gas circulation pump, wherein water to be measured is placed in the test container, an inlet of the carbon dioxide detector is in communication with the test container, an outlet of the carbon dioxide detector is in communication with the test container via the gas circulation pump to form a pipeline loop for recirculating carbon dioxide, and the first constant-temperature heating unit is provided on the test container to control the temperature of the measured water in a constant temperature state.

The present invention has the following advantageous effects in comparison with the prior art: The present invention provides a measurement method and system for the precipitation speed of an inorganic salt in water, an electronic device, and a storage medium, wherein the measurement method is to calculate the precipitation speed of target inorganic salts in water by measuring the change over time of the carbon dioxide concentration in water or the carbon dioxide concentration in gas phase in balance with the concentration of carbon dioxide in the water under a closed constant-temperature and constant-pressure environment under the condition that the type of inorganic salt precipitated is confirmed in the previous water quality analysis and one of the inorganic carbon methyl orange alkalinity in water, pH, total dissolved inorganic carbon, the total dissolved solid content of water, and the inorganic carbon methyl orange alkalinity contributed by the target inorganic salts and the content thereof are known. The measurement method provided by the present invention can be automatically processed and calculated by a computer program, and the present invention can improve the efficiency of protocol evaluation when testing the precipitation speed of target inorganic salts in water in a laboratory and verifying the precipitation speed adjustment protocol, thus greatly improving the measurement accuracy and reducing the manual effort. Also, the present invention is applied to the on-site measurement of the precipitation speed of an inorganic salt in water and optimization of the precipitation speed adjustment scheme, providing a measurement system for the precipitation speed of an inorganic salt in water with a small measurement lower limit, less manual intervention, and a short measurement time, and providing an excellent tool for on-site automatic optimal adjustment of the precipitation speed of an inorganic salt. The present invention has great potential in water treatment intelligence, including, but not limited to, applications in the following fields: Circulating cooling water, surface water, geothermal water, drinking water, concentrated water in a reverse osmosis water system, concentrated water in thermal seawater desalination, water with deposition tendency of colloidal silicon dioxide and magnesium silicate, scaling measurement and regulation in brine vacuum salt production process, scaling measurement and regulation of related water systems in oil and gas exploitation, etc.

### BRIEF DESCRIPTION OF THE DRAWINGS

FIG. 1 is a schematic view showing a measurement flow for the precipitation speed of an inorganic salt in water according to an embodiment of the present invention;

FIG. 2 is a schematic view showing the structure of a carbon dioxide concentration detector according to an embodiment of the present invention;

FIG. 3 is a block diagram of the principle of a measurement system for the precipitation speed of an inorganic salt in water according to an embodiment of the present invention;

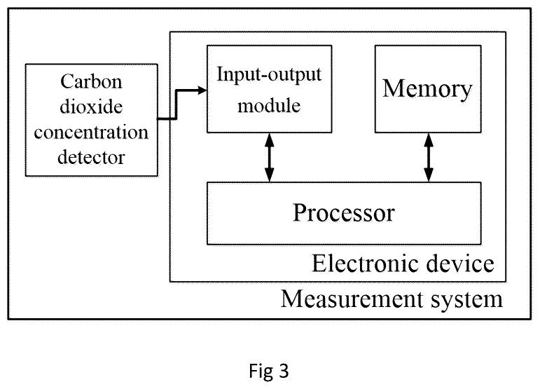

FIGS. 4a and 4b are statistical plots of PCO₂ over time for the calcium carbonate precipitation rate measurements of the embodiments;

FIG. 5 is a schematic view showing a comparison between the calcium carbonate precipitation rates calculated by the inventive embodiments and the conventional alkalinity titration method;

FIG. 6a is a PCO₂ recording of field water and scale inhibitor supplemented field water at various test temperatures. FIG. 6b is the PCO₂ linear regression for the last 0.5 hours measured at 25° C., and FIG. 6c is the PCO₂ linear regression for the last 0.5 hours measured at 55° C. and 75° C.; and

FIG. 7 is a statistical plot of the results of calcium carbonate precipitation rate calculations for Type 1 field water.

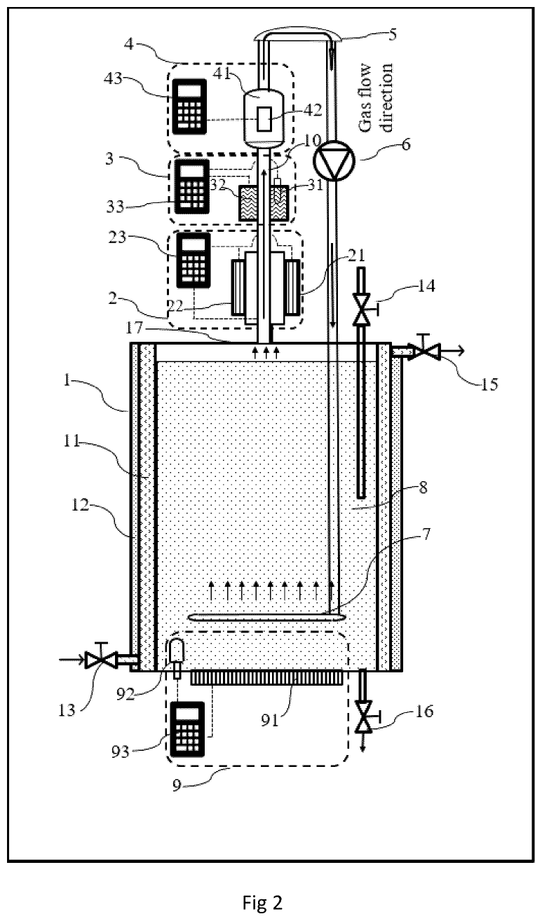

In FIG. 2:
1—test container, 10—pipeline, 11—jacket, 12—insulation layer, 13—jacketed water inlet valve, 14—test cup water inlet valve, 15—jacket water outlet valve, 16—test cup water outlet valve, 17—connection hole, 2—gas constant-temperature cooling unit, 21—first temperature sensor, 22—refrigeration sheet, 23—first controller, 3—second constant-temperature heating unit, 31—second temperature sensor, 32—heating wire, 33—second controller, 4—carbon dioxide detector, 41—measurement cavity, 42—carbon dioxide sensor, 43—display converter, 5—gas-phase pressure equalizing bag, 6—gas circulation pump, 7—gas distributor, 8—water to be measured, 9—first constant-temperature heating unit, 91—heater, 92—third temperature sensor, 93—third controller.

### DETAILED DESCRIPTION OF THE INVENTION

The invention will now be further described with reference to the accompanying drawings and examples.

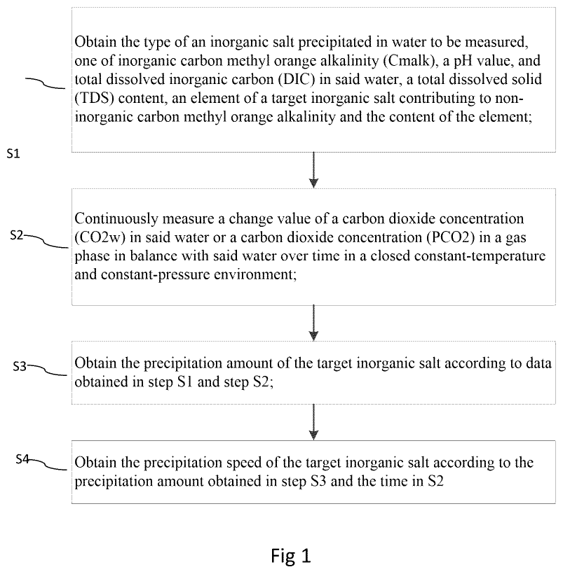

FIG. 1 is a schematic view showing a measurement flow for the precipitation speed of an inorganic salt in water according to an embodiment of the present invention.

Referring to FIG. 1, the measurement method for the precipitation speed of an inorganic salt in water provided in the present embodiment comprises the following steps:
S1: obtaining the type of an inorganic salt precipitated in water to be measured, one of inorganic carbon methyl orange alkalinity (Cmalk), a pH value, and total dissolved inorganic carbon (DIC) in said water, a total dissolved solid content of the test water (which can be converted from the electrical conductivity of the water), an element of a target inorganic salt contributing to non-inorganic carbon methyl orange alkalinity and an initial content of the element;
the alkalinity of water refers to the total amount of substances contained in the water that can quantitatively react with strong acids. The methyl orange alkalinity is the total amount of strong acid (120) contained in the water that can be quantitatively neutralized by the strong acid to the point at which the methyl orange indicator changes from yellow-orange to red-orange (solution pH4.4 to 4.5). Depending on the quality of the water, the source of the methyl orange alkalinity in the water varies.

Water containing inorganic carbon methyl orange alkalinity means water containing carbon dioxide, bicarbonate, and carbonate. The relationship between the three existing forms of inorganic carbon and the hydrogen ion concentration (H+) in water and the inorganic carbon methyl orange alkalinity (Cmalk) in water containing the inorganic carbon methyl orange alkalinity has been well studied and quantified. The following is a brief description:

$$D I C = {CO}_{2} w \times ( 1 + {k}_{1}^{′} / ( {H}^{+} ) + {k}_{1}^{′} \times {k}_{2}^{′} / {( {H}^{+} )}^{⋀} 2 ) , \qquad ( 1 )$$

$$Cmalk = 50000 \times {CO}_{2} w \times ( {k}_{1}^{′} / ( {H}^{+} ) + 2 {k}_{1}^{′} \times {k}_{2}^{′} / {( {H}^{+} )}^{⋀} 2 ) \qquad ( 2 )$$

$$pH = - log ( {H}^{+} ) \qquad ( 3 )$$

Where CO₂w is the carbon dioxide concentration in the water to be measured, H⁺ is the hydrogen ion concentration in the water to be measured, the negative logarithm thereof is the pH of the solution, k′₁ is the first dissociation constant of carbonic acid corrected by the temperature and the ionic strength of water, k′₂ is the second dissociation constant of carbonic acid corrected by the temperature and the ionic strength of water, and k′₁ and k′₂ can be selected or calculated from the available data and data according to the water quality characteristics of the water to be measured, the water temperature and the solid content of the water. It can be seen from the above-mentioned formulas (1), (2), and (3) that in the four of DIC, Cmalk, pH, and CO₂w, knowing any two of the four can know the other two; In a closed measurement system with constant temperature and pressure, if one of the initial DIC, Cmalk and pH of water is known, and then CO₂w is measured, it is feasible to calculate the unknown two of the previous three.

Under certain conditions, the precipitation and dissolution of different kinds of inorganic salts in water occur. There are many existing knowledge and calculation software to judge and calculate the possible sediment types and thermodynamic tendencies in the target water. The present invention classifies into three categories whether the total methyl orange alkalinity (Tmalk) and the total dissolved inorganic carbon (DIC) in the water are altered after precipitation of the inorganic salts. Type 1 is both changed, type 2 is only changed Tmalk, and type 3 is both unchanged. Table 1 lists the classification results of the common inorganic scale according to this classification principle and the quantitative change relationship of the components in the water after precipitation. It can be seen from Table 1 that after calcium carbonate is precipitated, Cmalk and DIC of water are reduced, and the total dissolved inorganic phosphorus (DIP) and total dissolved inorganic silicon (DISi) are not changed; The precipitation of calcium sulfate did not change Tmalk and DIC, DIP, DISi; After calcium phosphate precipitation, pmalk and DIP of water decreased but DIC did not change; The precipitation of magnesium silicate reduces the Simalk of water but does not change the DIC; colloidal silicon is a self-polymer of silicic acid, and each molecule of silicic acid polymerizes to produce a hydroxide that increases the alkalinity of the water without altering the DIC. In summary, when type 1 or type 2 scale is produced in water, the Tmalk in the water will change, changing the balance of the carbonate system, causing a change in pH and CO₂w. According to the change value of CO₂w, combined with the quantitative relationship between the precipitation amount of type 1 scale and type 2 scale and Tmalk, DIC, DIP, and DIsi, the corresponding precipitation amount of inorganic salts can be calculated.

TABLE 1
Quantitative changes of components in water after precipitation of common insoluble inorganic salts

| | | | | | | | | Change of Element | | | |
|---|---|---|---|---|---|---|---|---|---|---|---|
| | | | Change of Methyl Orange Alkalinity | | | | | DIC | DIP | DISi | |
| | Chemical | Molecular | Tmalk* | Cmalk | Pmalk | Simalk | OHmalk | mmol/mmol Salt | | | |
| Name | Formula | Weight | (mg as (CaCO₃/mmol Salt Precipitation) | | | | | Precipitation | | | Type |
| Calcium | CaCO₃ | 100 | −100 | −100 | 0 | 0 | 0 | −1 | 0 | 0 | 1 |
| Carbonate | | | | | | | | | | | |
| Calcium | CaSO₄ | 136 | 0 | 0 | 0 | 0 | 0 | 0 | 0 | 0 | 3 |
| Sulfate | | | | | | | | | | | |
| Calcium | Ca₃(PO₄)₂ | 310 | −200 | 0 | −200 | 0 | 0 | 0 | −2 | 0 | 2 |
| phosphate | | | | | | | | | | | |
| magnesium | MgSiO₃ | 100 | −100 | 0 | 0 | −100 | 0 | 0 | 0 | −1 | 2 |
| silicate | | | | | | | | | | | |
| colloidal | SiO₂ | 60 | 50 | 0 | 0 | 0 | 50 | 0 | 0 | −1 | 2 |
| silicon | | | | | | | | | | | |

*Tmalk = Cmalk + Pmalk + Simalk + OHmalk

S2: measuring a change value of a carbon dioxide concentration CO₂w in said water or a carbon dioxide concentration PCO₂ in a gas phase in balance with said water over time in a closed constant-temperature and constant-pressure environment;

For the measurement of carbon dioxide concentration, it is feasible to directly detect the concentration of CO₂w in the water or detect the concentration of PCO₂ in the gas phase space which is in balance with the water level, and then calculate the concentration of CO₂w of the carbon dioxide in the water according to the Henry constant Kh of carbon dioxide, i.e. calculated by PCO₂×Kh.

Referring to FIG. 2, in one embodiment, a closed detector having a total volume of 500 ml with constant temperature heating and cooling is set up to detect the carbon dioxide concentration in a gas phase in balance with the water to be measured 8. A gas circulation pump 6 and a carbon dioxide detector 4 are provided in the closed detector loop. During the test, the carbon dioxide concentration in a gas phase was continuously recorded. Specifically, the closed detector comprises a test container 1, a carbon dioxide detector 4, a first constant-temperature heating unit 3, and a gas circulation pump 6, wherein water to be measured 8 is placed in the test container 1, an inlet of the carbon dioxide detector 4 is in communication with the test container 1, an outlet of the carbon dioxide detector 4 is in communication with the test container 1 via the gas circulation pump 6 to form a pipeline loop for recirculating carbon dioxide, and a first constant-temperature heating unit 9 is provided on the test container 1 to control the temperature of the test water in a constant-temperature state.

In a particular embodiment, the test container 1 can be a test cup with a diameter of 65 mm and a height of 150 mm coated with a Teflon coating inside, a test cup water inlet valve 14 and a test cup water outlet valve 16 are provided on the test cup, a jacket 11 is provided, the jacket 11 is wrapped outside the test container 1, a heat insulation layer 12 is provided on the outer side of the jacket 11, and a jacket water inlet valve 13 and a jacket water outlet valve 15 are provided on the jacket 11; A connection hole 17 is opened at the top cover of the test container 1, and the connection hole 17 is connected to a pipeline 10; in the present embodiment, the pipeline 10 is a 304 stainless steel pipe with an outer diameter of 16 mm and an inner diameter of 9 mm; a gas constant-temperature cooling unit 2 and a second constant-temperature heating unit 3 are successively provided outside the pipeline between the test container 1 and the carbon dioxide detector 4; the gas constant-temperature cooling unit 2 comprises a first temperature sensor 21, a refrigeration sheet 22 and a first controller 23, wherein the refrigeration sheet 22 is wrapped outside the pipeline, and a cooling surface of the refrigeration sheet 22 is tightly connected to an outer stainless steel pipe via metal tin; A first temperature sensor 21 is arranged between the cold sink 22 and the pipe, i.e. the first temperature sensor 21 is provided between the metallic tin and the stainless steel outer pipe, and a first controller 23 (PID control) is electrically connected to the first temperature sensor 21 and the cold sink 22, and controls the temperature in the metallic tin and the stainless steel pipe at a first predetermined value, which may be 5±0.5° C., the stainless steel pipe length of the cooling section being 40 mm in the present embodiment. The second constant-temperature heating unit 3 comprises a heating wire 32, a second temperature sensor 31, and a second controller 33, wherein the heating wire 32 is wound outside a stainless steel pipe, and in the present embodiment, the heating wire 32 is formed by two Teflon low-voltage heating wires with an outer diameter of 1.2 mm and a resistance of 10 ohms per meter and wound in parallel for 20 turns, so as to form a heating section with a total length of 48 mm on the stainless steel pipe. A second temperature sensor 31 is disposed between the stainless steel outer pipe wall and the heating wire 32, and a second controller 33 (PID control) is electrically connected to the heating wire 32 and the second temperature sensor 31 to control the pipeline temperature at a second predetermined value, the second predetermined value being greater than the first predetermined value. In this embodiment, the second controller 33 controls the temperature of the stainless steel outer pipe wall to be 55±0.5° C. The gas constant-temperature cooling unit 2 and the second constant-temperature heating unit 3 were set up to meet the requirements of the carbon dioxide sensor 41 (SenseAir S8/004-0-0053, manufactured by SenseAir, Sweden) selected in this test for measuring the humidity in the gas. By setting up the gas constant-temperature cooling unit 2 and the second constant-temperature heating unit 3, the measured gas is cooled first and then heated, so as to reduce the humidity in the measured gas. In other embodiments, the carbon dioxide sensor 41, the gas constant-temperature cooling unit 2, and the second constant-temperature heating unit 3, which are selected to have a high humidity adaptability, may be omitted.

After passing through the gas constant-temperature cooling unit 2 and the second constant-temperature heating unit 3 to reduce the humidity, the measurement gas enters a carbon dioxide detector 4, which comprises a measurement cavity 41, a carbon dioxide sensor 42, and a display converter 43. In the present embodiment, the measurement cavity 41 is a 316 stainless steel cylinder with an inner diameter of 25 mm and a height of 45 mm, the bottom of the measurement cavity 41 is connected to the upper part of the pipeline 10, and the top of the measurement cavity 41 is connected to the gas-phase pressure equalizing bag 5 via a 316 stainless steel capillary pipe with a diameter of 3 mm. A carbon dioxide sensor 42 is built in the measurement cavity 41, and the carbon dioxide sensor 42 is connected to a display converter 43, and the carbon dioxide concentration is measured and recorded once per minute by the display converter 43. The gas-phase pressure equalizing bag 5 is a Teflon film-coated aluminum foil gas bag having a length of 100 mm and a width of 80 mm, respectively. One of the two ports of the gas-phase pressure equalizing bag 5 is connected to the measurement cavity 41, and the other port is connected to a capillary pipe and then connected to the gas circulation pump 6, and the outlet of the gas circulation pump 6 is connected to the measurement container 1 via a 316 capillary pipe with a diameter of 3 mm and passes the gas into the measurement water through the gas distributor 7, and the gas circulation flow rate is 60±20 ml/min. The first constant-temperature heating unit 9 is used for heating and constant-temperature testing water and comprises a heater 91, a third temperature sensor 92 and a third controller 93, wherein the heater 91 is provided outside the bottom of the measurement container 1, the third temperature sensor 92 is provided inside the measurement container 1, and the third controller 93 is respectively electrically connected to the third temperature sensor 92 and the heater 91, and controls the temperature of the water to be measured 8 to be at a third pre-set temperature. When the test temperature is higher than 25 degrees centigrade, the test water is heated and thermostated using the first thermostatic unit 9. When the test temperature is equal to or less than 25° C., the test water temperature is maintained by the external constant-temperature water through the test cup jacket 11. According to the measurements, the volume of the whole test system was 500 ml at 25° C. The temperature of the test water was stabilized to the set point 20-25 minutes after the start of the test, as measured by the pre-measurement data of the system temperature control. Temperature deviation was at constant temperature±0.5° C.
S3: obtaining the precipitation amount of the target inorganic salt according to data obtained in step S1 and step S2; and
In the first embodiment, the target inorganic salt is calcium carbonate, and there are no other ions contributing to the non-inorganic carbon methyl orange alkalinity in the water to be measured, which specifically comprises the following steps:
S311: knowing Cmalk(t₀) and CO₂w(t₀) at t₀, and calculating H⁺(t₀) and DIC(t₀) at the starting time t₀ according to formulas (2) and (1);
S312: Having obtained H⁺(t₀) and DIC(t₀) from S311, and knowing CO₂w(t₁) at t₁, calculating H⁺(t₁) at t₁ according to formula (5), then calculating DIC(t₁) according to formula (1), and calculating Cmalk(t₁) according to formula (2),

The calculation procedure of formula (5) is as follows: Precipitation of the calcium carbonate reduces the total dissolved inorganic carbon in the water and the methyl orange alkalinity contained causes a reduction in the inorganic carbon methyl orange alkalinity in the water, both equal in value. On the left side of formula (4), the content of methyl orange alkalinity of precipitated calcium carbonate is shown, and on the right side of formula (4), the variation amount of inorganic carbon methyl orange alkalinity in water is shown, which are equal to each other. From formula (4), it can be calculated to formula (5)

$$( D I {C}_{( t 0 )} - D I {C}_{( t 1 )} ) \times 100 \times 1000 = ( {Cmalk}_{( t 0 )} - {Cmalk}_{( t 1 )} ) \qquad ( 4 )$$

$$∨$$

$${10}^{⋀} 5 \times D I {C}_{( t 0 )} - {10}^{⋀} 5 \times D I {C}_{( t 1 )} = {Cmalk}_{( t 0 )} - {Cmalk}_{( t 1 )}$$

$$∨$$

$${10}^{⋀} 5 \times {CO}_{2} w ( {t}_{0} ) \times ( {k}_{1}^{′} / {H}_{( t 0 )}^{+} + {k}_{1}^{′} \times {k}_{2}^{′} / {( {H}_{( t 0 )}^{+} )}^{⋀} 2 - {10}^{⋀} 5 \times {CO}_{2} w ( {t}_{1} ) \times {k}_{1}^{′} / {H}_{( t 0 )}^{+} + {k}_{1}^{′} \times {k}_{2}^{′} / {( {H}_{( t 0 )}^{+} )}^{⋀} 2 = {CO}_{2 ( t 0 )} \times ( 500 \; 00 \times {k}_{1}^{′} / {H}_{( t 0 )}^{+} + 100000 \times {k}_{1}^{′} {k}_{2}^{′} / ( {{H}_{( t 0 )}^{+}}^{⋀} 2 ) - {CO}_{2 ( t 1 )} \times ( 50000 \times {k}_{1}^{′} / {H}_{( t 1 )}^{+} + 100000 \times {k}_{1}^{′} {k}_{2}^{′} / ( {{H}_{( t 1 )}^{+}}^{⋀} 2 )$$

$$∨$$

$$2 \times {CO}_{2} w ( {t}_{0} ) - 2 \times {CO}_{2} w ( {t}_{1} ) = {CO}_{2} w ( {t}_{1} ) \times {k}_{1}^{′} / {H}^{+} ( {t}_{1} ) - {CO}_{2} w ( {t}_{0} ) \times {k}_{1}^{′} / {H}^{+} ( {t}_{0} ) \qquad ( 5 )$$

S313: Calculate the calcium carbonate precipitation amount according to formula (6)

$$calcium carbonate precipitation amount {CaCO}_{3} = ( D I C ( {t}_{0} ) - D I C ( {t}_{1} ) ) * {10}^{⋀} 5 \qquad ( 6 )$$

The unit of calcium carbonate precipitation amount CaCO₃ is mg/L. In a second embodiment, the target inorganic salt is calcium phosphate, and there is no ion contributing to the inorganic carbon methyl orange alkalinity other than the inorganic carbon methyl orange alkalinity contributed by orthophosphate in the water to be measured, which specifically comprises the following steps:
S321: knowing Cmalk(t₀) and CO₂w(t₀) at t₀, and calculating H⁺(t₀) and DIC(t₀) at the starting time t₀ according to formulas (2) and (1);
S322: knowing CO₂w(t₁) and Cmalk(t₁) at t₁, calculating DIC(t₁) and H⁺(t₁) at t₁ according to formula (7),

$$D I C ( {t}_{0} ) = D I C ( {t}_{1} ) = {CO}_{2} w ( {t}_{1} ) \times ( 1 + {k}_{1}^{′} / {H}^{+} ( {t}_{1} ) + {k}_{1}^{′} {k}_{2}^{′} / ( {{H}^{+} ( {t}_{1} )}^{⋀} 2 ) ) \qquad ( 7 )$$

The non-carbonate precipitation does not change the DIC, and the H⁺(t₁) is obtained from formula (7).
S323: Knowing Tp(t₀) at t₀, obtaining DIP(t₀) according to formula (9), and calculating formula (13) according to formulas (10)-(12), then calculating Pmalk(t₀) according to formula (13), calculating DIP(t₁) and Pmalk(t₁) according to formulas (8) and (13), and calculating calcium phosphate precipitation amount according to formula (14);

$$( D I P ( {t}_{0} ) - D I P ( {t}_{1} ) ) / 2 \times 2 \times 50 \times 1000 = Cmalk ( {t}_{0} ) + Pmalk ( {t}_{0} ) - Cmalk ( {t}_{1} ) - Pmalk ( {t}_{1} ) \qquad ( 8 )$$

$$D I P = Tp / 95 / 1000 \qquad ( 9 )$$

$$Pmalk = ( {PO}_{4}^{3 -} ) \times 2 \times 50000 + ( {HPO}_{4}^{2 -} ) \times 1 \times 50 \; 000 \qquad ( 10 )$$

$$( {PO}_{4}^{3 -} ) = D I P \times {kp}_{1} \times {kp}_{2} \times {kp}_{3} / ( {( H + )}^{⋀} 3 + {( H + )}^{⋀} 2 \times {kp}_{1} + ( H + ) \times {kp}_{1} \times {kp}_{2} + {kp}_{1} \times {kp}_{2} \times {kp}_{3} ) \qquad ( 11 )$$

$$( {HPO}_{4}^{2 -} ) = ( {PO}_{4}^{3 -} ) \times ( {H}^{+} ) / {kp}_{3} \qquad ( 12 )$$

$$Pmalk = ( D I P \times {kp}_{1} \times {kp}_{2} \times {kp}_{3} / ( {( H + )}^{⋀} 3 + {( H + )}^{⋀} 2 \times {kp}_{1} + ( H + ) \times {kp}_{1} \times {kp}_{2} + {kp}_{1} \times {kp}_{2} \times {kp}_{3} ) ) \times 2 \times 50000 + ( D I P \times {kp}_{1} \times {kp}_{2} \times {kp}_{3} / ( {( H + )}^{⋀} 3 + {( H + )}^{⋀} 2 \times {kp}_{1} + ( H + ) \times {kp}_{1} \times {kp}_{2} + {kp}_{1} \times {kp}_{2} \times {kp}_{3} ) ) \times ( H + ) / {kp}_{3} \times 1 \times 50000 \qquad ( 13 )$$

$$Calcium phosphate precipitation amount {Ca}_{3} {( {PO}_{4} )}_{2} = D I P ( {t}_{0} \text{---} ) - D I P ( {t}_{1} ) / 2 \times 310 \times 1000 \qquad ( 14 )$$

wherein Pmalk is the inorganic phosphorus methyl orange alkalinity mg/L, calculated as calcium carbonate, DIP is the total dissolved inorganic phosphorus mol/L, and Tp is the total dissolved inorganic phosphorus content mg/L, calculated as PO₄³⁻; kp₁ is the first ionization constant of phosphoric acid, kp₂ is the second ionization constant of phosphoric acid, and kp₃ is the third ionization constant of phosphoric acid.

After calcium phosphate precipitation, the total dissolved inorganic phosphorus (DIP) in the water and the methyl orange alkalinity (non-inorganic carbon methyl orange alkalinity) contributed by phosphate are decreased. On the left side of formula (8), the methyl orange alkalinity expressed by the precipitated calcium phosphate is decreased, and on the right side, the methyl orange alkalinity in the water is decreased, both of which should be equal.

CO₂w(t₀)=PCO₂t₀×Kh and Cmalk(t₀) is a known value, H⁺(t₀) can be calculated according to formula (2), and then DIC(t₀) can be obtained according to formula (1). Calcium phosphate does not contain carbonate and does not change DIC in water after precipitation from water, i.e. DIC(t₁)=DIC(t₀) Thus, H⁺(t₁) can be obtained according to formula (7), and Cmalk(t₁) can be obtained according to formula (2). So far, only DIP(t₁) and Pmalk(t₁) in formula (8) are unknown, and DIP(t₁) and Pmalk(t₁) need to satisfy formula (13); therefore, DIP(t₁) and Pmalk(t₁) can be solved by formula (8) and formula (13). One method for solving this problem is the trial difference method of DIP(t₁). By setting different values of DIP(t₁), DIP(t₁) and Pmalk(t₁) satisfying formula (8) and formula (13) are calculated, and then the precipitation amount of calcium phosphate is obtained according to formula (14).

In a third embodiment, the target inorganic salt is magnesium silicate, and the water to be measured has no ions contributing to the inorganic carbon methyl orange alkalinity other than the inorganic carbon methyl orange alkalinity contributed by the silicate, which specifically comprises the following steps:
S331: knowing Cmalk(t₀) and CO₂w(t₀) at t₀, and calculating H⁺(t₀) and DIC(t₀) at the starting time t₀ according to formulas (2) and (1);
S332: knowing CO₂w(t₁) and Cmalk(t₁) at t₁, calculating DIC(t₁) and H⁺(t₁) at t₁ according to formula (7);

$$D I C ( {t}_{0} ) = D I C ( {t}_{1} ) = {CO}_{2} w ( {t}_{1} ) \times ( 1 + {k}_{1}^{′} / {H}^{+} ( {t}_{1} ) + {k}_{1}^{′} {k}_{2}^{′} / ( {{H}^{+} ( {t}_{1} )}^{⋀} 2 ) ) \qquad ( 7 )$$

S333: knowing Tsi(t₀) at t₀, obtaining DISi(t₀) according to formula (16), calculating Simalk(t₀) according to formulas (17) and (18), and calculating DISi(t₁) according to formulas (15)-(18), and calculating the magnesium silicate precipitation amount according to formula (19);

$$( D I S i ( {t}_{0} ) - D I S i ( {t}_{1} ) ) \times 2 \times 50 \times 1000 = Cmalk ( {t}_{0} ) + Simalk ( {t}_{0} ) - Cmalk ( {t}_{1} ) - Simalk ( {t}_{1} ) \qquad ( 15 )$$

$$D I S i = Tsi / 60 / 1000 \qquad ( 16 )$$

magnesium silicate precipitation amount MgSiO₃=(DISi(t₀)−DISi(t₁))×2×50×1000 (19)
wherein DISi is the total dissolved inorganic silicon mol/L, Tsi is the total dissolved silicon content mg/L, calculated as SiO₂, Simalk is the inorganic silicon methyl orange alkalinity mg/L, calculated as calcium carbonate, and Ksi is the dissociation constant of silicic acid.

The alkalinity in the water decreases after the magnesium silicate is precipitated. On the left side of formula (15), the methyl orange alkalinity expressed by the precipitated magnesium silicate is shown, and on the right side, the alkalinity shown in the water decreases, and both of them need to be equal.

CMalk(t₀) and CO₂w(t₀)=PCO₂(t₀)*Kh are known values, and H⁺(t₀) can be calculated according to formula (2), and then DIC(t₀) can be obtained according to formula (1). Magnesium silicate precipitates from water, reducing the methyl orange alkalinity of water and causing a decrease in pH. Since the non-carbonate basicity does not contain inorganic carbon, the DIC of the water remains unchanged. According to formula (7), H⁺(t₁) and then Cmalk(t₁) can be obtained. It can be seen from the molecular formula of magnesium silicate that when 1 mol/L of magnesium silicate is precipitated while reducing 1 mol/L of total dissolved silicon, the alkalinity calculated as calcium carbonate of 2×50×1000 be mg/L will reduced, namely, (DISi(t₀)−DISi(t₁))×2×50×1000=Talk(t₀)−Talk(t₁). Knowing the total dissolved inorganic silicon concentration at t₀, Tsi(t₀), and knowing the H⁺(t₀) at t₀, the basicity contributed by the silicon at t₀, Simalk(t₀), can be calculated from the dissociation constant of silicic acid. When a value of DISi(t1) is set, Simalk(t₁) can be calculated from the dissociation constant constant of H⁺(t₁) and silicic acid. Therefore, trial and error calculation can be performed on DISi(t₁) to find DISi(t₁) satisfying formula (15), and then the precipitation amount of magnesium silicate can be obtained according to formula (19).

In a fourth embodiment, the target inorganic salt is colloidal silicon, and no ions are contributing to the inorganic carbon methyl orange alkalinity other than the inorganic carbon methyl orange alkalinity contributed by silicate in the water to be measured, and the specifically comprises the following steps:
S341: knowing Cmalk(t₀) and CO₂w(t₀) at t₀, and calculating H⁺(t₀) and DIC(t₀) at the starting time t₀ according to formulas (2) and (1);
S342: knowing CO₂w(t₁) and Cmalk(t₁) at t₁, calculating DIC(t₁) and H⁺(t₁) at t₁ according to formula (7), calculating Cmalk(t₁) at t₁ according to formula (2);

$$D I C ( {t}_{0} ) = D I C ( {t}_{1} ) = {CO}_{2} w ( {t}_{1} ) \times ( 1 + {k}_{1}^{′} / {H}^{+} ( {t}_{1} ) + {k}_{1}^{′} {k}_{2}^{′} / ( {{H}^{+} ( {t}_{1} )}^{⋀} 2 ) ) \qquad ( 7 )$$

S343: knowing Tsi(t₀) at t₀, obtaining DISi(t₀) according to formula (16), calculating Simalk(t₀) according to formulas (17) and (18), and calculating DISi(t₁) according to formulas (16)-(18) and (20), and calculating the colloidal silicon precipitation amount according to formula (21);

$$( D I s i ( {t}_{0} ) - D I s i ( {t}_{1} ) ) \times 1 \times 50 \times 1000 = - ( Cmalk ( {t}_{0} ) + Simalk ( {t}_{0} ) ) + ( Cmalk ( {t}_{1} ) + Simalk ( {t}_{1} ) ) \qquad ( 20 )$$

$$D I S i = Tsi / 60 / 1000 \qquad ( 16 )$$

$$Simalk = 500 \; 00 \times ( {Si ( OH )}_{3} {O}^{-} ) = 50 \; 000 \times D I S i / ( 1 + {H}^{+} / Ksi ) \qquad ( 17 )$$

$$colloidal silicon precipitation amount {SiO}_{2} = ( D I S i ( {t}_{0} ) - D I S i ( {t}_{1} ) ) \times 1 \times 60 \times 1000 \qquad ( 21 )$$

wherein DISi is the total dissolved inorganic silicon content mol/L, Tsi is the total dissolved inorganic silicon content mg/L, calculated as SiO₂, Simalk is the inorganic silicon methyl orange alkalinity mg/L, calculated as calcium carbonate, and Ksi is the dissociation constant of silicic acid; The unit of the precipitation amount of colloidal silicon SiO₂ is mg/L.

Cmalk(t₀) and CO₂w(t₀)=PCO₂(t₀)*Kh are known values, and H⁺(t₀) can be calculated according to formula (2), and then DIC(t₀) can be calculated according to formula (1); since colloidal silicon does not contain inorganic carbon, the DIC of water remains unchanged. According to formula (7), H⁺(t₁) and then Cmalk(t₁) can be obtained.

Colloidal silicon is the self-polymerization of orthosilicic acid, and each orthosilicic acid, after polymerization, produces a hydroxide in water and increases in alkalinity in water. On the left side of the formula (20) is a quantitative expression that the precipitated colloidal silicon increases the alkalinity of water while decreasing the total dissolved inorganic silicon (DISi, mol/L), and on the right side is the alkalinity increase exhibited in water, both of which need to be equal.

Knowing the total dissolved inorganic silicon concentration Tsi at t₀, DISi(t₀) can be obtained from formula 16, and then the basicity Simalk(t₀) contributed by silicon at to can be calculated according to the known dissociation constant of H⁺(t₀) combined with dissociation constant of silicic acid at to. Thus, in formula (20), DISi(t₁) and Simalk(t₁) remain unknown, DISi(t₁) and Simalk(t₁) satisfy formula (17) again, and H⁺(t₁) is a known value. Therefore, DISi(t₁) and Simalk(t₁) can be solved according to formula (20) and formula (17). One method of solving this problem is the DISi(t₁) trial-and-error method, finding the DISi(t₁) satisfying formulas (20) and (17), and then obtaining the precipitation amount of colloidal silicon according to formula (21).

S4: The precipitation speed of the target inorganic salt is obtained based on the precipitation amount obtained in step S3.

The precipitation amount is divided by the time (t₁−t₀) at which the precipitation amount occurs, i.e. the average precipitation speed over the test period is obtained.

The present embodiment also provides an electronic device, comprising: a processor; a memory, and a computer program stored in the memory and operable on the processor, when the computer program is executed by the processor, the above-mentioned measurement method for the precipitation speed of an inorganic salt is implemented.

The present embodiment also provides a computer-readable storage medium storing a computer program that, when being executed by a processor, the above-mentioned measurement method for the precipitation speed of an inorganic salt is implemented.

### Example 1

This example calculates the calcium carbonate precipitation speed from the results of the carbon dioxide concentration PCO₂ in gas phase measurement according to calculation software developed in the present invention.

It is known that the water to be measured has a tendency to precipitate calcium carbonate, and there are no other ions contributing to the inorganic carbon methyl orange alkalinity in the water to be measured. This water was known to have a Cmalk of 320 mg/L and a TDS of 1118 mg/L. 470 ml of test water was added into the test device, the test water temperature was set as 25° C., the test device was started, and PCO₂ was continuously measured and recorded. After one hour, the test was ended. From the PCO₂ recorded in the test, PCO₂=994 ppmv at 30 minutes and PCO₂=1099 ppmv at 60 minutes of the test. Table 2 lists the specific steps for calculating the calcium carbonate precipitation amount by calculation software developed in accordance with the present invention. The precipitation amount calculated from Table 2, divided by the time that the precipitation amount occurred, gave an average precipitation rate over the test period of time of 1.8/0.5=3.6 mg/L/hour.

TABLE 2
Calculation process of calcium carbonate precipitation amount

| Test water | 25 |
|---|---|
| temperature | |
| (T), ° C. | |
| Volume of test | 470 |
| water (Vw), ml | |
| Total dissolved | 1118 |
| solids (TDS), | |
| mg/L | |

| | | Calculated |
|---|---|---|
| | Correlation constant value formula | Value |
| K′w, the | 10\hat{ }(6.0486 − 4471.33/(T + 273.15) − | 1.28E−14 |
| dissociation | 0.017053*(T + 273.15) − 2 × logfm | |

constant of water
at set
temperature and
ionic strength

| | | |
|---|---|---|
| k₁′, first order | 10\hat{ }(14.8435 − 3404.71/(T + 273.15) − | 6.16E−07 |
| dissociation | 0.032786*(T + 273.15) − 2 × logfm | |

constant for
carbonic acid at
set temperature
and ionic
strength

| | | |
|---|---|---|
| k₂′, second order | 10\hat{ }(6.498 − 2909.39/(T + 273.15) − | 8.49E−11 |
| dissociation | 0.02379*(T + 273.15) − logfd | |

constant of
carbonic acid at
set temperature
and ionic
strength

| | | |
|---|---|---|
| Ks′, calcium | 10\hat{ }(13.87 − 3059/(T + 273.15) − | 1.39E−08 |
| carbonate | 0.04035*(T + 273.15) − 2 × logfd | |

solubility
product constant
at set
temperature and
ionic strength

| | | |
|---|---|---|
| log Kh | =108.3865 + 0.01985076*(T + 273.15) − | −1.47E+00 |
| | 6919.53/(T + 273.15) − 40.45154*LOG(T + | |
| | 273.15) + 669365/(T + 273.15)\hat{ }2 | |
| Kh CO₂, Henry | =10\hat{ }logKh*10\hat{ } − 6 | 3.405E−08 |

constant for
carbon dioxide at
set temperature,
(mol/L)/ppmv

| | | |
|---|---|---|
| Logfm, the | A × ((I\hat{ }0.5/(1 + I\hat{ }0.5) − 0.2*I)) | −0.07050468 |

logarithm of the
first order
activity constant
fm

| | | |
|---|---|---|
| Logfd, the | 4*logfm | −0.282018719 |

logarithm of the
second-order
activity constant
fd

| | | |
|---|---|---|
| A | 1.825*10\hat{ }6*(E*(T + 273.15))\hat{ } − 1.5 | 0.512217497 |
| E. the dielectric | 60954/(T + 389.15) − 68.937 | 78.24155849 |

constant of water

| | | |
|---|---|---|
| I. Ionic Intensity | 2.5*10\hat{ } − 5*TDS | 0.02795 |

I/O and computational logic interpretation

| Type of scale | Type 1, precipitate calculated as calcium carbonate | | Input value and the | |
|---|---|---|---|---|
| | | | calculation result | |
| Variation law of | (DICₜ₀ − DICₜ₁) × 100000 = Cmalkₜ₀ − Cmalkₜ₁ | | | |
| ions in water | | | | |
| after scale | | | | |
| precipitation | | | | |
| | Time, t₀ | Time, t₁ | Time, | Time, |
| | | | t₀ | t₁ |
| carbon dioxide | The measured values are entered into the Input and Calculation Results | | 994 | 1099 |
| concentration in | | | | |
| gas phase | | | | |
| Concentration | | | | |
| (PCO₂), ppmv | | | | |
| Carbon dioxide | Be calculated by PCO₂ × Kh | | 3.38E−05 | 3.74E−05 |
| concentration in | | | | |
| water CO₂w, | | | | |
| mol/L | | | | |
| Inorganic carbon | The basicity of inorganic carbon at t₀ shall be input | Calculating H⁺(t₁) at t₁ according to formula | 320.0 | 318.2 |
| CMalk, mg/L | | (5), and using a pH trial and error method, | | |
| calculated as | | obtaining Cmalk(t₁) according to formula | | |
| CaCO₃ | | (2), calculating DIC(t₁) at t₁ according to | | |
| Total dissolved | From formulas (2) and (3), the pH at t₀ can be found. | formula (4), and calculating pH(t₁) at t₁ | 6.28E−03 | 6.26E−03 |
| inorganic carbon | One way to solve this problem is the trial-and-error | according to formula (3), | | |
| (DIC), mol/L | method, namely, setting different pH values, and | | | |
| pH | finally obtaining the pH value at which Cmalk(t₀) is | | 8.47 | 8.42 |
| | equal to the given value. After the pH is obtained, | | | |
| | DICₜ₀ can be obtained by formula (2) | | | |
| Need to maintain | DIC(t₀)*10\hat{ }5 − Cmalk(t₀) | 10\hat{ }5 × CO₂wₜ₁ × (1 + k′₁/(H⁺ₜ₁₎ + | 3.08E+02 | 3.08E+02 |
| an equal amount | | k′₁k′₂/(H⁺ₜ₁₎\hat{ }2) − | | |
| between t0 and | | CO₂wₜ₁ × (50000*k′₁/H⁺ₜ₁ + | | |
| t1 | | 100000 × k′₁k′₂/(H⁺ₜ₁)\hat{ }2) | | |

| | |
|---|---|
| Calculated precipitation amount in Calcium Carbonate, CaCO₃, mg/L | 1.8 |

The specific application of the present invention in laboratory testing of the crystallization reaction characteristics of the target inorganic salt (Process 1) is further described below.

### Example 2

This example is a calcium carbonate crystallization precipitation test.

In the laboratory, in order to evaluate the crystallization reaction characteristics of the target inorganic salt precipitated from water, one of the existing methods was the static scale inhibition method. Two kinds of stock solutions were prepared. When the two kinds of stock solutions were mixed and under a certain test environment, the crystallization of the target inorganic salt would be produced. By analyzing the concentrations of the target ions before and after the test, the precipitation characteristics of the target inorganic salts were quantitatively evaluated. In this test, while obtaining the calcium carbonate precipitation rate using the carbon dioxide concentration measurement device and calculation method of the present invention, the total methyl orange alkalinity of the water before and after the test was analyzed to obtain a set of data similar to that of the conventional static scale inhibition test, thereby calculating the calcium carbonate precipitation amount and deposition rate from the data and comparing the two sets of data.

### 1. Preparation for Test

### 1) Preparation of Stock Solution of 0.5 mg (Effective) ATMP/ml

0.25 g of 50% ATMP (a commonly used scale inhibitor, aminotrimethylene phosphinic acid, purchased from Taobao, Yousuo sample Xiaolindian) was weighed into a 200 ml beaker, about 100 ml deionized water was added, mixed well, pH was adjusted to 7.0±0.1 with 0.1 N NaOH, and then deionized water was used to make constant volume to 250 ml.

### 2) Preparation of Stock Solutions A and B

Stock solution A: 1.813 g of NaHCO₃(analytically pure, traditional Chinese medicine) was weighed into a 200 ml beaker, dissolved with about 100 ml of deionized water, and transferred to a 2 L volumetric flask, 0.127 g of Na₂CO₃ (analytically pure, traditional Chinese medicine) was weighed into a 200 ml beaker, dissolved with 100 ml of deionized water and transferred to a 2 L volumetric flask, the 200 ml beaker was washed with deionized water for 2-3 times, and the wash solution was transferred to a 2 L volumetric flask. The stock solution A was repeatedly prepared once, and the twice prepared stock solution A was put into a 5-liter glass bottle after mixing, and then the bottle cap was tightly covered for future use.

Stock solution B: 1.763 g of CaCl₂*2H₂O (analytically pure, Fuchen (Tianjin) Chemical Reagent Co. Ltd.) was weighed into a 200 ml beaker, dissolved with about 100 ml of deionized water, transferred to a 2 L volumetric flask, then the 200 ml beaker was washed with deionized water for 2-3 times, the wash solution was transferred to the 2 L volumetric flask, deionized water was used to make constant volume to the 2 L volumetric flask. The stock solution B was repeatedly prepared, and the twice prepared stock solution B was put into a 5-liter glass bottle after mixing, and then the bottle cap was tightly covered for future use.

3) Titration of initial methyl orange alkalinity: a volumetric flask was used to take 250 ml of stock solution A, another volumetric flask was used to take 250 ml of deionized water, and the two liquids were mixed and stored in a 500 ml glass bottle with cover. The sample was filtered with a 0.45-micron filter membrane (water system MCE 25 mm, filtration technology), the sample was transferred with a 50 ml pipette into a 200 ml conical flask, 3-5 drops of 0.1% methyl orange indicator was added, and then titrated with 0.05N HCl standard solution (Taobao, laboratory standard reagent business). Each sample was repeated 3 times, averaged, and the standard deviation was calculated.

### 2. Calcium Carbonate Crystallization Test

A 250 ml volumetric flask was used to take 250 ml of the stock solution A and was put into a 1000 ml beaker; according to the test design, different amounts of ATMP stock solution were added; another 250 ml volumetric flask was used to take 250 ml of the stock solution B and was put into a 1000 ml beaker in which the stock solution A had been stored, and then a glass rod was used to stir until uniform. The calculated water quality of the two stock solutions after mixing in equal amounts is shown in Table 3. According to the relevant calculation software, it could be seen that the calcite supersaturation index of the test solution was 1.68 at 25° C. 470 g of the test solution was taken, and placed in the test device, the test constant temperature was set at 25° C., and the test time was 1 h. PCO₂ was continuously recorded during this period and plotted over time after the end of the test. After 1 hour, the test solution was filtered with a 0.45-micron filter membrane, the sample was transferred with a 50 ml pipette into a 200 ml conical flask, 3-4 drops of methyl orange indicator was added, and then 0.05N HCl was used to titrate. The sample was repeated 3 times, averaged, and calculated the standard deviation.

TABLE 3
Water quality of calcium carbonate precipitation test

| | |
|---|---|
| Na⁺, mg/L | 138 |
| Ca²⁺, mg/L as CaCO₃ | 300 |
| Cmalk, mg/L as CaCO₃ | 300 |
| Cl⁻, mg/L | 212 |
| PH, room temperature | 8.63 |
| Supersaturation Index SI at 25° C. | 1.68 |
| calculated for calcite (chemical | |
| composition calcium carbonate) | |
| from aqion* | |

*aqion is a free water quality calculation software that can determine the dissolution and deposition tendencies of 261 minerals based on water quality. Download web site: https://www.aqion.de/direct/8.1.2_EN

### 3. Test Results

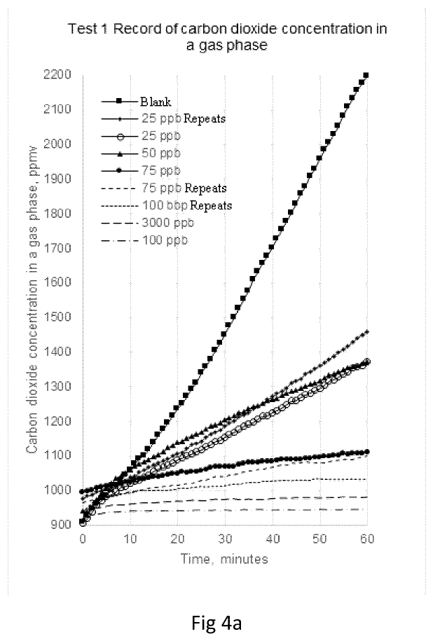

Table 4 shows the test arrangement and the statistics of test results. FIG. 4a and FIG. 4b are statistical plots of PCO₂ over time.

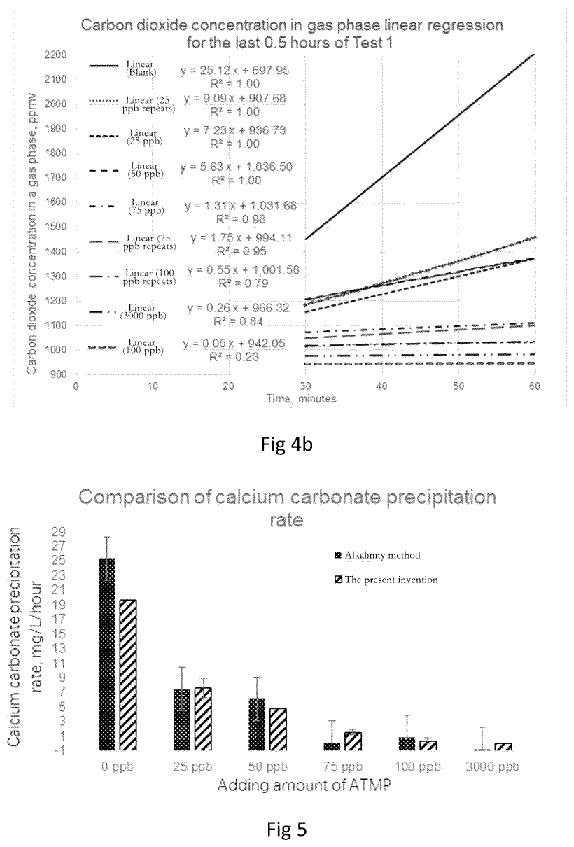

It can be seen from the measurement of the constant temperature characteristics of the previous test device that the water temperature can be kept constant at 25±0.5° C. only after about 20-25 minutes from the start of the test. Therefore, the slope and intercept were calculated by linear regression of the data from the test time of 30 minutes to 60 minutes, see FIG. 5, and the PCO₂ of 0 minutes and 60 minutes were calculated from the slope and intercept, and then the calcium carbonate precipitation amount and the deposition rate were calculated from the values. The results of the final calculations are collectively listed in Table 4.

TABLE 4
Calcium Carbonate Crystallization Test Arrangement and Results

| | | Test No. | | | | | | | | |
|---|---|---|---|---|---|---|---|---|---|---|
| | | 1# | 2# | 3# | 4# | 5# | 6# | #7 | 8# | 9# |
| | | Test Abbreviation | | | | | | | | |
| | | 25 | | 100 | 50 | 75 | 3000 | 75 ppb | 100 bbp | 25 ppb |
| | | ppb | Blank | ppb | ppb | ppb | ppb | repeats | repeats | repeats |
| Adding amount of ATMP, | | 25 | 0 | 100 | 50 | 75 | 3000 | 75 | 100 | 25 |
| μg/L based on the | | | | | | | | | | |
| active substance | | | | | | | | | | |
| 500 ml volume of 0.5 mg | | 25 | 0 | 100 | 50 | 75 | 3000 | 75 | 100 | 25 |
| (active) ATMP/ml | | | | | | | | | | |
| to be added to the | | | | | | | | | | |
| test solution, μl | | | | | | | | | | |
| Initial Inorganic | Theoretical | 300 | | | | | | | | |
| Carbon Alkalinity, | formulation | | | | | | | | | |
| mg/L as CaCO₃ | concentration | | | | | | | | | |
| | Test 1 | 322.2 | | | | | | | | |
| | Test 2 | 320.8 | | | | | | | | |
| | Test 3 | 318.5 | | | | | | | | |
| | Avg | 320.5 | | | | | | | | |
| | Standard | 1.9 | | | | | | | | |
| | Deviation | | | | | | | | | |
| Initial Ca²⁺ (calculated | | 300 | | | | | | | | |
| according to theoretical | | | | | | | | | | |
| preparation value), mg/L is | | | | | | | | | | |
| calculated as CaCO₃ | | | | | | | | | | |
| Conductivity, μs/cm | Measured value | 1199 | 1245 | 1228 | 1251 | Not | 1223 | 1258 | 1258 | 1254 |
| (room temperature) | | | | | | Tested | | | | |
| | Avg | 1240 | | | | | | | | |
| | Standard | 21 | | | | | | | | |
| | Deviation | | | | | | | | | |
| Total dissolved solids*, mg/L | | 868 | | | | | | | | |
| Pre-test pH | Measured@ | 8.67 | 8.60 | 8.62 | 8.62 | Not | 8.52 | 8.67 | 8.66 | 8.70 |
| | Temp° C. | @17.3 | @15.8 | @15.8 | @18.2 | Tested | @16.2 | @16.9 | @17.2 | @16.7 |
| | Avg | 8.63 | | | | | | | | |
| | Standard | 0.06 | | | | | | | | |
| | Deviation | | | | | | | | | |
| Supersaturation Index SI | | 1.68 | | | | | | | | |
| at 25° C. calculated | | | | | | | | | | |
| for calcite (chemical | | | | | | | | | | |
| constituent calcium | | | | | | | | | | |
| carbonate) from aqion* | | | | | | | | | | |
| Test temperature, ° C. | | 25 | | | | | | | | |
| Alkalinity measured | Test 1 | 312.8 | 290.2 | 320.7 | 315.7 | 319.8 | 318.3 | 320.1 | 321.3 | NA |
| after the test, mg/L | Test 2 | 310.3 | 300.2 | 322.4 | 314.7 | 323.9 | 320.3 | 322.8 | 319.8 | NA |
| is calculated as | Test 3 | 316.2 | 295.2 | 321.4 | 312.7 | 317.3 | 325.3 | 318.5 | 318.3 | NA |
| CaCO₃ | Avg | 313.1 | 295.2 | 321.5 | 314.4 | 320.3 | 321.3 | 320.5 | 319.8 | NA |
| | STDEV | 3.0 | 5.0 | 0.9 | 1.5 | 3.3 | 3.6 | 2.2 | 1.5 | NA |
| Calcium carbonate | | 7.4 | 25.3 | −1.0 | 6.1 | 0.2 | −0.8 | 0.0 | 0.7 | NA |
| precipitation amount | | | | | | | | | | |
| calculated from | | | | | | | | | | |
| alkalinity, mg/L | | | | | | | | | | |
| calculated as CaCO₃ | | | | | | | | | | |

| | | | | | | | | | |
|---|---|---|---|---|---|---|---|---|---|
| Slope, ppmv/hour, | 7.23 | 25.11 | 0.05 | 5.63 | 1.31 | 0.26 | 1.75 | 0.55 | 9.09 |
| 0.5 hours after carbon | | | | | | | | | |
| dioxide concentration | | | | | | | | | |
| in a gas phase | | | | | | | | | |
| Intercept 0.5 hours | 936.73 | 697.95 | 942.05 | 1036.5 | 1031.68 | 996.32 | 994.11 | 1001.58 | 907.68 |
| after carbon dioxide | | | | | | | | | |
| concentration in | | | | | | | | | |
| a gas phase, ppmv | | | | | | | | | |
| PCO₂(0)*, ppmv | 937 | 698 | 942 | 1037 | 1032 | 996 | 994 | 1002 | 908 |
| PCO₂(60)*, ppmv | 1371 | 2205 | 945 | 1374 | 1110 | 1012 | 1099 | 1035 | 1453 |
| PCO₂(60) − | 434 | 1507 | 3 | 338 | 79 | 16 | 105 | 33 | 545 |
| PCO₂(0), ppmv | | | | | | | | | |
| Calcium carbonate | 6.6 | 19.6 | 0.1 | 4.8 | 1.3 | 0.3 | 1.8 | 0.6 | 8.5 |
| deposition speed | | | | | | | | | |
| calculated from PCO₂, | | | | | | | | | |
| mg/L CaCO₃/hour | | | | | | | | | |

*Total dissolved solids (mg/L) as 0.7 * Conductivity (μs/cm)

FIG. 5 lists a schematic view of a comparison of calcium carbonate deposition rates calculated according to the present invention and by conventional alkalinity titration.

As can be seen from this test,
1) In terms of CaCO₃, the absolute error of alkalinity titration is around 5 mg/L, i.e. the resolution of the calcium carbonate deposition rate calculated by the alkalinity method is less than 5 mg/L/hour.
2) As can be seen from the two repeating data of the 25 bbp, 75 bbp, 100 ppb inventive method, the resolution of the inventive method is around 2 mg/L/hour.
3) With the adding amount of 0 ppb ATMP, the deviation of the results obtained by the two methods was relatively large, about 5 mg/L/hour. The probable reason is that since the sample with no scale inhibitor remained at a higher deposition rate after 1 hour, the sample filtration took about 15 minutes and each alkalinity measurement took about 5 minutes, so the data measured by the alkalinity method is actually about 1.5 hours, 25/1.5=17 mg/L/hour, which is close to that measured by the method of the present invention.
4) The present invention does not require a high-intensity alkalinity titration, has a small amount of work, has continuous test data, does not require manual intervention, and has high reliability.

### Example 3

Specific examples of the application of the present invention in Process 2 (in-situ application for testing the crystallization reaction characteristics of inorganic salts) are further described below.

In a certain circulating cooling water, municipal tap water was used as make-up water, and phosphorus-free circulating water was used for corrosion and scale inhibition treatment. It was found that the scaling control of some high-temperature heat exchangers was not good, and the treatment scheme of scale inhibition and corrosion inhibitor was proposed to be adjusted. The water quality analysis results of field water are shown in Table 5. According to the water quality and water supply source, the main scaling inorganic salt of the circulating water was calcium carbonate.

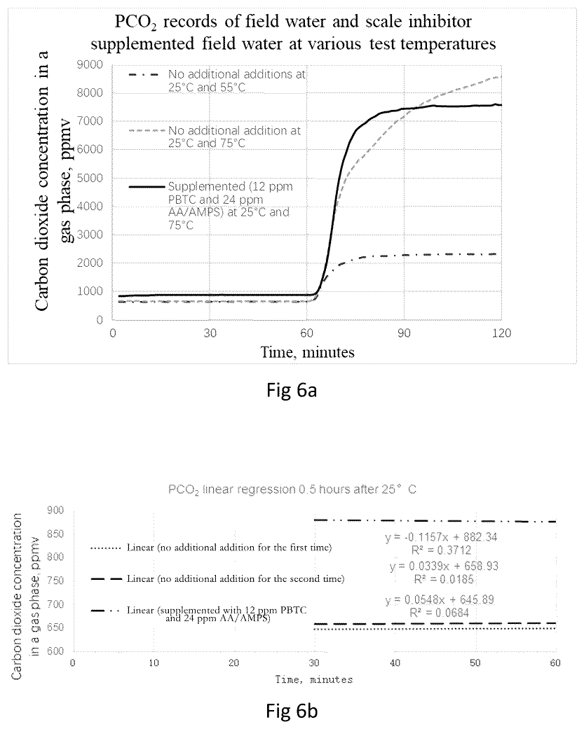

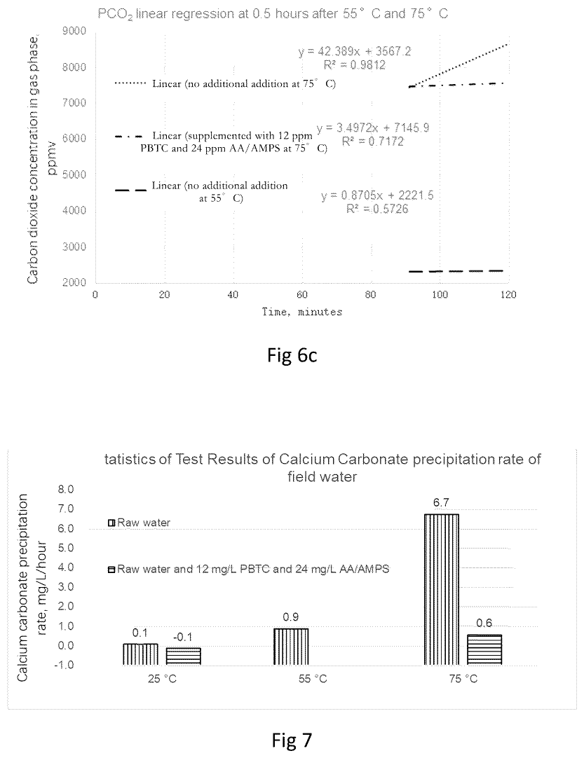

Take the field circulating water, use the method of the present invention to measure the field water and the field water supplemented with scale inhibitor at 25° C., 55° C. and 75° C., according to the method of the present invention, calculate with the precipitation rate calculation method for inorganic salt precipitated type 1 calcium carbonate. Table 5 shows the experimental setup and results. FIG. 6a is a PCO₂ recording of field water and scale inhibitor supplemented field water at various test temperatures. FIG. 6b is the PCO₂ linear regression for the last 0.5 hours measured at 25° C., and FIG. 6c is the PCO₂ linear regression for the last 0.5 hours measured at 55° C. and 75° C. FIG. 7 is a statistical plot of the results of calcium carbonate precipitation rate calculations for Type 1 field water. It can be seen from FIG. 7 that at 25° C. and 55° C., the field water precipitation rate as calcium carbonate is less than 0.9 mg/L/hour. However, as the temperature increases to 75° C., the field water precipitation rate as calcium carbonate without supplementing scale inhibitor increases rapidly to 6.7 mg/L/hour, with the scale inhibitor supplemented still remaining at about 0.6 mg/L/hour, which is comparable to that without scale inhibitor at 55° C. For high-temperature heat exchangers, the current on-site chemical treatment scheme needs to be adjusted. One method is to increase the concentration of scale inhibitor. Other methods can also be used in view of the cost of the reagent. For example, the pH is lowered. On-site After adjusting the treatment protocol, water may again be taken to determine the precipitation speed of inorganic salts using the method of the present invention until an optimal protocol for inorganic salt precipitation control is found.

TABLE 5
Field Water Test Arrangement and Results

| Test No. | 1# | 2# | 3# |
|---|---|---|---|
| Abbreviation | No additional | No additional | Add 12 |
| | additions of | addition at | ppmPBTC and |
| | 25° C. and | 25° C. and | 24 ppm |
| | 55° C. | 75° C. | AA/AMPS |
| | | | 25° C. and 75° C. |
| Test time | 60 minutes + 60 minutes | | |
| Initial Cmalk, mg/L as CaCO₃ | 280 | | |
| Ca²⁺, mg/L as CaCO₃ | 490 | | |
| Total dissolved solids *, mg/L | 1427 | | |
| Conductivity, μs/cm (room | 2039 | | |
| temperature) | | | |
| Test pH Measured@Room | 8.68 @24° C. | | |
| Temperature | | | |
| SI of CaCO₃ @25 C. by aqion | 1.82 | | |
| supplemented PBTC, mg/L | 0 | 0 | 12 |
| Supplemented with AA/AMPS, mg/L | 0 | 0 | 24 |
| Test temperature, ° C. | 25 | | |
| Slope half hour after PCO₂, | 0.0548 | 0.0339 | −0.1157 |
| ppmv/hour | | | |
| Intercept Half Hour After PCO₂, | 646 | 659 | 882 |
| ppmv | | | |
| PCO₂(0), ppmv | 646 | 659 | 882 |
| PCO₂(60), ppmv | 649 | 661 | 875 |
| PCO₂(60) − PCO₂(0), ppmv | 3 | 2 | −7 |
| Calcium Carbonate precipitation | 0.1 | 0.1 | −0.1 |
| speed, mg/L CaCO₃/hour | | | |
| Test temperature, ° C. | 55 | 75 | |
| Slope half hour after PCO₂, | 0.8705 | 42.389 | 3.4972 |
| ppmv/hour | | | |
| Intercept Half Hour After PCO₂, | 2222 | 3567 | 7146 |
| ppmv | | | |
| PCO₂(60), ppmv | 2274 | 6111 | 7356 |
| PCO₂(120), ppmv | 2378 | 8654 | 7566 |
| PCO₂(60) − PCO₂(120), ppmv | 104 | 2543 | 210 |
| Calcium Carbonate precipitation | 0.9 | 6.7 | 0.6 |
| speed, mg/L CaCO₃/hour | | | |

* Total dissolved solids as conductivity * 0.70

From the above experiments, it can be seen that in order to test the above data, the present invention takes only 6 hours, the calculation process is fully programmed, and only the initial Cmalk (or pH, or DIC) and TDS (which can be converted by conductivity) of water are manually input. Frequent, complex alkalinity or calcium ion analysis is not required.

Although the present invention has been described with reference to preferred embodiments, it is not to be restricted by the embodiments but only by those skilled in the art. Accordingly, the scope of the present invention should be determined by that of the appended claims.

1. A measurement method for the precipitation speed of an inorganic salt in water, characterized by comprising the following steps:
S1: obtaining the type of an inorganic salt precipitated in water to be measured, one of inorganic carbon methyl orange alkalinity (Cmalk), a pH value, and total dissolved inorganic carbon (DIC) in said water, total dissolved solid content (TDS), an element of a target inorganic salt contributing to non-inorganic carbon methyl orange alkalinity and an initial content of the element;
S2: continuously measuring a change value of a carbon dioxide concentration (CO2w) in said water or a carbon dioxide concentration (PCO2) in a gas phase in balance with said water over time;
S3: obtaining the precipitation amount of the target inorganic salt according to data obtained in step S1 and step S2;
S4: obtaining the precipitation speed of the target inorganic salt according to the precipitation amount obtained in step S3 and the time in S2.

2. The measurement method according to claim 1, characterized in that, in said step S1, the other two of the inorganic carbon methyl orange alkalinity (Cmalk), the pH value, and the total dissolved inorganic carbon (DIC) in water are calculated according to the following formulas:
$$D I C = {CO}_{2} w \times ( 1 + {k}_{1}^{′} / ( {H}^{+} ) + {k}_{1}^{′} \times {k}_{2}^{′} / {( {H}^{+} )}^{⋀} 2 ) , \qquad ( 1 )$$
$$Cmalk = 50000 \times {CO}_{2} w \times ( {k}_{1}^{′} / ( {H}^{+} ) + 2 {k}_{1}^{′} \times {k}_{2}^{′} / {( {H}^{+} )}^{⋀} 2 ) , \qquad ( 2 )$$
$$pH = - log ( {H}^{+} ) \qquad ( 3 )$$
where DIC is the total dissolved inorganic carbon concentration in the water (mol/L), CO2w is the carbon dioxide concentration in the water to be measured (mol/L), Cmalk is the inorganic carbon methyl orange alkalinity in the water (mg/L, calculated as calcium carbonate), H+ is a hydrogen ion concentration in the water to be measured (mol/L), k′1 is a first dissociation constant of carbonic acid, and k′2 is a second dissociation constant of carbonic acid.

3. The measurement method according to claim 2, characterized in that the target inorganic salt is calcium carbonate, and there are no other ions contributing to the inorganic carbon methyl orange alkalinity in the water to be measured, said step S3 comprises the following steps:
S311: knowing Cmalk(t0) and CO2w(t0) at t0, and calculating H+(t0) and DIC(t0) at the starting time t0 according to formulas (2) and (1);
S312: knowing CO₂w(t1) at t1, calculating H+(t1) at t1 according to formula (5), calculating Cmalk(t1) at t1 according to formula (2), and calculating DIC(t1) at t1 according to formula (4),
$$( D I C ( {t}_{0} ) - D I C ( {t}_{1} ) ) \times 100 \times 1000 = ( Cmalk ( {t}_{0} ) - Cmalk ( {t}_{1} ) ) \qquad ( 4 )$$
$$2 \times {CO}_{2} w ( {t}_{0} ) - 2 \times {CO}_{2} w ( {t}_{1} ) = {CO}_{2} w ( {t}_{1} ) \times {k}_{1}^{′} / {H}^{+} ( {t}_{1} ) - {CO}_{2} w ( {t}_{0} ) \times {k}_{1}^{′} / {H}^{+} ( {t}_{0} ) \qquad ( 5 )$$
S313: calculating the calcium carbonate precipitation amount according to formula (6)
$$calcium carbonate precipitation amount {CaCO}_{3} = D I C ( {t}_{0} ) - D I C ( {t}_{1} ) * {10}^{⋀} 5 \qquad ( 6 )$$
wherein, the unit of calcium carbonate precipitation amount CaCO₃ is mg/L.

4. The measurement method according to claim 2, characterized in that the inorganic salt precipitated is calcium phosphate, and no ions are contributing to the inorganic carbon methyl orange alkalinity other than the inorganic carbon methyl orange alkalinity contributed by orthophosphate in the water to be measured, said step S3 comprises the following steps:
S321: knowing Cmalk(t0) and CO2w(t0) at t0, and calculating H+(t0) and DIC(t0) at the starting time t0 according to formulas (2) and (1);
S322: knowing CO₂w(t1) at t1, calculating DIC(t1) and H+(t1) at t1 according to formula (7), calculating Cmalk(t1) at t1 according to formula (2),
$$D I C ( {t}_{0} ) = D I C ( {t}_{1} ) = {CO}_{2} w ( {t}_{1} ) \times ( 1 + {k}_{1}^{′} / {H}^{+} ( {t}_{1} ) + {k}_{1}^{′} {k}_{2}^{′} / ( {{H}^{+} ( {t}_{1} )}^{⋀} 2 ) ) \qquad ( 7 )$$
S323: knowing Tp(t0) at t0, obtaining DIP(t0) according to formula (9), calculating Pmalk(t0) according to formulas (10)-(12), calculating DIP(t1) according to formulas (8)-(12), and calculating calcium phosphate precipitation amount according to formula (14);
$$( D I P ( {t}_{0} ) - D I P ( {t}_{1} ) ) / 2 \times 2 \times 50 \times 1000 = Cmalk ( {t}_{0} ) + Pmalk ( {t}_{0} ) - Cmalk ( {t}_{1} ) - Pmalk ( {t}_{1} ) \qquad ( 8 )$$
$$D I P = Tp / 95 / 1000 \qquad ( 9 )$$
$$Pmalk = ( {PO}_{4}^{3 -} ) \times 2 \times 50000 + ( {HPO}_{4}^{2 -} ) \times 1 \times 50 \; 000 \qquad ( 10 )$$
$$( {PO}_{4}^{3 -} ) = D I P \times {kp}_{1} \times {kp}_{2} \times {kp}_{3} / ( {( H + )}^{⋀} 3 + {( H + )}^{⋀} 2 \times {kp}_{1} + ( H + ) \times {kp}_{1} \times {kp}_{2} + {kp}_{1} \times {kp}_{2} \times {kp}_{3} ) \qquad ( 11 )$$
$$( {HPO}_{4}^{2 -} ) = ( {PO}_{4}^{3 -} ) \times ( {H}^{+} ) / {kp}_{3} \qquad ( 12 )$$
$$Calcium phosphate precipitation amount {Ca}_{3} {( {PO}_{4} )}_{2} = D I P ( {t}_{0} ) - D I P ( {t}_{1} ) / 2 \times 310 \times 1000 \qquad ( 14 )$$
wherein Pmalk is the inorganic phosphorus methyl orange alkalinity (mg/L, calculated as calcium carbonate), DIP is the total dissolved inorganic phosphorus concentration (mol/L), Tp is the total dissolved inorganic phosphorus concentration (mg/L, calculated as PO43−); kp1 is the first ionization constant of phosphoric acid, kp2 is the second ionization constant of phosphoric acid, and kp3 is the third ionization constant of phosphoric acid.

5. The measurement method according to claim 2, characterized in that the target inorganic salt is magnesium silicate, and no ions are contributing to the inorganic carbon methyl orange alkalinity other than the inorganic carbon methyl orange alkalinity contributed by silicate in the water to be measured, said step S3 comprises the following steps:
S331: knowing Cmalk(t0) and CO2(t0) at t0, and calculating H+(t0) and DIC(t0) at the starting time t0 according to formulas (2) and (1);
S332: knowing CO2(t1) at t1, calculating DIC(t1) and H+(t1) at t1 according to formula (7), calculating Cmalk(t1) at t1 according to formula (2).
$$D I C ( {t}_{0} ) = D I C ( {t}_{1} ) = {CO}_{2} w ( {t}_{1} ) \times ( 1 + {k}_{1}^{′} / {H}^{+} ( {t}_{1} ) + {k}_{1}^{′} {k}_{2}^{′} / ( {{H}^{+} ( {t}_{1} )}^{⋀} 2 ) ) \qquad ( 7 )$$
S333: knowing Tsi(t0) at t0, obtaining DISi(t0) according to formula (16), calculating Simalk(t0) according to formulas (17) and (18), calculating DISi(t1) according to formulas (15)-(18), and calculating the magnesium silicate precipitation amount according to formula (19);
$$( D I S i ( {t}_{0} ) - D I S i ( {t}_{1} ) ) \times 2 \times 50 \times 1000 = Cmalk ( {t}_{0} ) + Simalk ( {t}_{0} ) - Cmalk ( {t}_{1} ) - Simalk ( {t}_{1} ) \qquad ( 15 )$$
$$D I S i = Tsi / 60 / 1000 \qquad ( 16 )$$
$$Simalk = 500 \; 00 \times ( {Si ( OH )}_{3} {O}^{-} ) \qquad ( 17 )$$
$$( {Si ( OH )}_{3} {O}^{-} ) = D I S i / ( 1 + {H}^{+} / Ksi ) \qquad ( 18 )$$
magnesium silicate precipitation amount MgSiO₃=(DISi(t₀)−DISi(t₁))×2×50×1000 (19)
wherein DISi is the total dissolved inorganic silicon content mol/L, Tsi is the total dissolved inorganic silicon content mg/L, calculated as SiO₂, Simalk is the inorganic silicon methyl orange alkalinity mg/L, calculated as calcium carbonate, and Ksi is the dissociation constant of silicic acid; and the unit of magnesium silicate precipitation amount MgSiO3 is mg/L.

6. The measurement method according to claim 2, characterized in that the target inorganic salt is colloidal silicon, and no ions are contributing to the inorganic carbon methyl orange alkalinity other than the inorganic carbon methyl orange alkalinity contributed by silicate in the water to be measured, said step S3 comprises the following steps:
S341: knowing Cmalk(t0) and CO2w(t0) at t0, and calculating H+(t0) and DIC(t0) at the starting time t0 according to formulas (2) and (1);
S342: knowing CO2(t1) and Cmalk(t1) at t1, calculating DIC(t1) and H+(t1) at t1 according to formula (7), calculating Cmalk(t1) at t1 according to formula (2),
$$D I C ( {t}_{0} ) = D I C ( {t}_{1} ) = {CO}_{2} w ( {t}_{1} ) \times ( 1 + {k}_{1}^{′} / {H}^{+} ( {t}_{1} ) + {k}_{1}^{′} {k}_{2}^{′} / ( {{H}^{+} ( {t}_{1} )}^{⋀} 2 ) ) \qquad ( 7 )$$
S343: knowing Tsi(t0) at t0, obtaining DISi(t0) according to formula (16), calculating Simalk(t0) according to formulas (17) and (18), calculating DISi(t1) according to formulas (16)-(18) and (20), and calculating colloidal silicon precipitation amount according to formula (21);
$$( D I S i ( {t}_{0} ) - D I S i ( {t}_{1} ) ) \times 1 \times 50 \times 1000 = - ( Cmalk ( {t}_{0} ) + Simalk ( {t}_{0} ) ) + ( Cmalk ( {t}_{1} ) + Simalk ( {t}_{1} ) ) \qquad ( 20 )$$
$$D I S i = Tsi / 60 / 1000 \qquad ( 16 )$$
$$Simalk = 5000 \; 0 \times ( {Si ( OH )}_{3} {O}^{-} ) \qquad ( 17 )$$
$$( {Si ( OH )}_{3} {O}^{-} ) = D I S i / ( 1 + {H}^{+} / Ksi ) \qquad ( 18 )$$
$$colloidal silicon precipitation amount {SiO}_{2} = ( D I S i ( {t}_{0} ) - D I S i ( {t}_{1} ) ) \times 1 \times 60 \times 1000 \qquad ( 21 )$$
wherein DISi is the total dissolved inorganic silicon content mol/L, Tsi is the total dissolved inorganic silicon content mg/L, calculated as SiO₂, Simalk is the inorganic silicon methyl orange alkalinity mg/L, calculated as calcium carbonate, and Ksi is the dissociation constant of silicic acid; the unit of the colloidal silicon precipitation amount SiO₂ is mg/L.

7. The measurement method according to claim 1, characterized in that said step S2 comprises: measuring a carbon dioxide gas concentration PCO2 in a closed detector, wherein a gas circulation pump and a gas phase carbon dioxide detector are provided in a loop of the closed detector, and continuously recording the carbon dioxide gas concentration PCO2 during measurement; then converting the carbon dioxide gas concentration PCO2 into the carbon dioxide concentration CO2w in water according to Henry's law.

8. An electronic device, characterized by comprising: a processor; a memory, and a computer program stored in the memory and operable on the processor, when the computer program is executed by the processor, the measurement method for the precipitation speed of an inorganic salt in water according to any one of claims 1-7 is implemented.

9. A computer-readable storage medium, characterized in that a computer program is stored in the storage medium, and when the computer program is executed by a processor, the measurement method for the precipitation speed of an inorganic salt in water according to any one of claims 1-7 is implemented.

10. A measurement system for the precipitation speed of an inorganic salt in water, characterized by comprising a closed detector for measuring carbon dioxide concentration and the electronic device according to claim 8, the electronic device further comprising an input-output module, an output end of the closed detector being in signal communication with the input-output module of the electronic device.

11. The measurement system according to claim 10, characterized in that the closed detector comprises a test container, a carbon dioxide detector, a first constant-temperature heating unit, and a gas circulation pump, wherein water to be measured is placed in the test container, an inlet of the carbon dioxide detector is in communication with the test container, an outlet of the carbon dioxide detector is in communication with the test container via the gas circulation pump to form a pipeline loop for recirculating carbon dioxide, and the first constant-temperature heating unit is provided on the test container to control the temperature of the test water in a constant temperature state.
